(19) United States
(12) Patent Application Publication
(10) Pub. No.: US 2025/0180937 A1
(43) Pub. Date: Jun. 5, 2025

(54) QUANTUM TRANSDUCTION WITH RESONANT CAVITIES

(71) Applicant: FERMI RESEARCH ALLIANCE, LLC, Batavia, IL (US)

(72) Inventor: Silvia Zorzetti, Batavia, IL (US)

(21) Appl. No.: 18/843,952

(22) PCT Filed: Mar. 9, 2023
(86) PCT No.: PCT/US2023/014928

§ 371 Date: Sep. 4, 2024

Related U.S. Application Data
(60) Provisional application No. 63/269,160, filed on Mar. 10, 2022.

(51) Int. Cl. G02F 1/035; G06N 10/40; H01P 7/06

(52) U.S. Cl. CPC G02F 1/0356; G06N 10/40; H01P 7/065; G02F 2201/06; G02F 2202/20; G02F 2203/15

(57) ABSTRACT

A transduction system comprises a resonant cavity, at least one electro-optic crystal configured in the resonant cavity proximate a beam pipe associated with the resonant cavity, at least one rod extending from the electro-optic crystal into the beam pipe, configured for bi-directional quantum transduction to up or down convert the information to/from the optical regime.

### CROSS REFERENCE TO RELATED APPLICATIONS

This patent application claims the priority and benefit under 35 U.S.C. § 119 (e) of U.S. Provisional Patent Application Ser. No. 63/269,160 filed Mar. 10, 2022, entitled “QUANTUM TRANSDUCTION WITH SUPERCONDUCTING 3D RESONATORS.” U.S.

Provisional Patent Application Ser. No. 63/269,160 is herein incorporated by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

The embodiments are generally related to the field of quantum devices. Embodiments further relate to the field of quantum computers and quantum computing. Embodiments are also related to quantum transduction and networks. Embodiments are further related to quantum communication.

### BACKGROUND

Quantum computing offers a new frontier in computing technology. Quantum computers may be capable of vastly increasing the computing power currently available using classic computers.

A “qubit” is the quantum computing equivalent of a bit in a classical computer. A bit is a means of encoding information, either as a zero or a one. In quantum computing, the qubit represents a similar mechanism for encoding information. However, in the case of qubits the state can be a zero, one, or a linear combination of those states simultaneously. As a result of the superposition of states possible in a qubit, quantum computers are situated to address certain computing problems much faster and more efficiently than classical computers.

Superconducting-based quantum devices are leading candidates for the construction of scalable quantum computers and quantum processing units (QPUs). However, these devices need to be cooled down to milli-Kelvin (mK) temperatures. In contrast, optical photons can carry information at room temperatures over long distances through fiber optic cables. Practically speaking there remain significant challenges to realizing the microwave-optical conversion. High-efficiency and low-noise transduction in the quantum level remains a difficult obstacle.

As such, systems and methods for quantum transduction are critically important for enabling engineering technology for complex quantum devices, networks, and sensors. The systems and methods disclosed herein address this need.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide for an improved system and method for quantum devices.

It is another aspect of the disclosed embodiments to provide quantum transduction.

The aforementioned aspects and other objectives and advantages can now be achieved as described herein. For example, bulk niobium (Nb) superconducting radiofrequency (SRF) cavities with extended microwave photon lifetime can be leveraged for use with hybrid coherent resonance systems and bi-directional quantum transduction. The associated SRF cavities offer a high quality factor to up/down-convert the information to/from the optical regime. The coupling between high-Q SRF cavities with nonlinear electro-optic resonators or modulators can support a powerful quantum network. Such quantum systems have very low parasitic losses and can maximize conversion efficiency at milli-Kelvin temperatures and offer high fidelity in quantum states transportation.

In an embodiment a system comprises a resonant bulk cavity and at least one electro-optic crystal configured in the resonant bulk cavity. In an embodiment, the resonant bulk cavity comprises an RF resonating cavity. In an embodiment, the system comprises at least one rod extending from the electro-optic crystal. In an embodiment, the at least one rod comprises three rods. In an embodiment, the at least one rod further comprises at least one sapphire rod. In an embodiment the system further comprises a beam pipe associated with the resonant bulk cavity wherein the at least one electro-optic crystal is configured proximate to the beam pipe. In an embodiment, the electro-optic crystal comprises one of Lithium Niobate (LiNbO₃) and Aluminum Nitride (AlN). In an embodiment, the resonant bulk cavity comprises a TESLA shaped cavity. In an embodiment, the resonant bulk cavity comprises one of a superconducting cavity and a microwave cavity. In an embodiment, the resonant bulk cavity comprises a split ring cavity. In an embodiment, the resonant bulk cavity comprises a bow-tie cavity.

In another embodiment, a transduction system comprises a resonant RF cavity, at least one electro-optic crystal configured in the resonant RF cavity proximate to a beam pipe associated with the resonant RF cavity, and at least one rod extending from the electro-optic crystal into the beam pipe. In an embodiment, the resonant RF cavity comprises one of a superconducting cavity and an RF resonating cavity. In an embodiment, resonant RF cavity comprises one of: a TESLA shaped cavity, a reentrant cavity, a split ring cavity, a bow-tie cavity, and a custom designed RF cavity. In an embodiment, the electro-optic crystal comprises one of Lithium Niobate (LiNbO₃) and Aluminum Nitride (AlN). In an embodiment, the at least one rod further comprises at least one sapphire rod.

In another embodiment a system comprises an EO transducer, a resonant cavity coupled to the EO transducer, a transmon qubit coupled to the EO transducer, and an RF source configured to provide a signal to the EO transducer. In an embodiment, the EO transducer comprises an RF resonating cavity and electro-optic crystal configured in the RF resonating cavity. In an embodiment, the RF resonating cavity comprises one of: a TESLA shaped cavity, a reentrant cavity, a split ring cavity, a bow-tie cavity, and a custom designed RF cavity. In an embodiment, the electro-optic crystal comprises Lithium Niobate (LiNbO₃) and Aluminum Nitride (AlN).

### BRIEF DESCRIPTION OF THE FIGURES

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1A illustrates a TESLA shaped SRF cavity and voltage across a crystal, in accordance with the disclosed embodiments;

FIG. 1B illustrates different designs of the TESLA shaped cavity hybridized with the crystal, in accordance with the disclosed embodiments;

FIG. 1C illustrates aspects of a TESLA shaped cavity with a crystal in accordance with the disclosed embodiments;

FIG. 2A illustrates a reentrant cavity design and electric fields distribution, in accordance with the disclosed embodiments;

FIG. 2B illustrates an exploded view of aspects of the reentrant cavity design and electric fields distribution, in accordance with the disclosed embodiments;

FIG. 3 illustrates a cross section of a split-ring cavity with a crystal, in accordance with the disclosed embodiments;

FIG. 4 illustrates a cross section of a bow-tie cavity with a crystal, in accordance with the disclosed embodiments;

FIG. 5A illustrates a dipole mode cavity with a crystal, with an integrated transmon qubit, in accordance with the disclosed embodiments;

FIG. 5B illustrates aspects of a dipole mode cavity with a crystal, in accordance with the disclosed embodiments;

FIG. 6A illustrates transduction efficiency as a function of pump power in accordance with the disclosed embodiments;

FIG. 6B illustrates cooperativity as a function of pump power in accordance with the disclosed embodiments;

FIG. 6C illustrates infidelity as a function of pump power in accordance with the disclosed embodiments;

FIG. 7 illustrates an electro-optic modulator coupled to a resonant cavity, in accordance with the disclosed embodiments;

FIG. 8 illustrates an electro-optic modulator coupled to a high-Q resonant cavity and transmon qubit, in accordance with the disclosed embodiments;

FIG. 9 illustrates an a high-Q SRF cavity coupled to a tansmon qubit, hybridized with a non-linear material in a dilution refrigerator, in accordance with the disclosed embodiments;

FIG. 10 illustrates interconnected systems through a superconducting coaxial cable or waveguide in a dilution refrigerator, in accordance with the disclosed embodiments;

FIG. 11 illustrates a block diagram of a transduction system for controls and measurements, in accordance with the disclosed embodiments;

FIG. 12 illustrates steps in a method for designing an arrangement of a cavity and a crystal for transduction, in accordance with the disclosed embodiments;

FIG. 13A illustrates an exemplary cavity with an embedded crystal for transduction, in accordance with the disclosed embodiments;

FIG. 13B illustrates an exemplary cavity with an embedded crystal for transduction with the cover removed, in accordance with the disclosed embodiments;

FIG. 13C illustrates an elevation view of an exemplary cavity with an embedded crystal for transduction, in accordance with the disclosed embodiments;

FIG. 13D illustrates an elevation view of an exemplary cavity with an embedded crystal for transduction, in accordance with the disclosed embodiments;

FIG. 14 illustrates an exemplary assembly associated with a cavity with an embedded crystal for transduction, in accordance with the disclosed embodiments;

FIG. 15 illustrates a mechanism to change microwave volume associated with a cavity with an embedded crystal in order to tune the resonant frequency, in accordance with the disclosed embodiments;

FIG. 16A illustrates a mechanism to tune microwave coupling associated with a cavity with an embedded crystal using an antenna, in accordance with the disclosed embodiments; and

FIG. 16B illustrates another mechanism to tune microwave coupling associated with a cavity with an embedded crystal using an antenna, in accordance with the disclosed embodiments.

### DETAILED DESCRIPTION

The particular values and configurations discussed in the following non-limiting examples can be varied, and are cited merely to illustrate one or more embodiments, and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein. Rather, these embodiments are provided so that this disclosure will be thorough and complete, and will fully convey the scope of the embodiments to those skilled in the art. Like reference numerals refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” a used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “In another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations. The principal features can be employed in various embodiments without departing from the scope disclosed herein. Those skilled in the art will recognize, or be able to ascertain, using no more than routine experimentation, numerous equivalents to the specific procedures described herein. Such equivalents are considered to be within the scope of the disclosed embodiments and are covered by the claims.

The use of the word “a” or “an” when used in conjunction with the term “comprising in the claims and/or the specification may mean “one,” but it is also consistent with the meaning of “one or more,” at “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of “having,” such as “have” and “has”), “including” (and any form of “including,” such as “includes” and “include”) or “containing” (and any form of “containing,” such as “contains” and “contain”) are inclusive or open-ended and do not exclude additional, un-recited elements or method steps.

All of the compositions and/or methods disclosed and claimed herein can be made and executed without undue experimentation in light of the present disclosure. While the compositions and methods have been described in terms of preferred embodiments, it will be apparent to those of skill in the art that variations may be applied to the compositions and/or methods and in the steps, or in the sequence of steps, of the method described herein without departing from the concept, spirit, and scope of the disclosed embodiments. All such similar substitutes and modifications apparent to those skilled in the art are deemed to be within the spirit, scope and concept as defined by the appended claims.

In the context of quantum computing, a qubit can be realized as an artificial atom with two levels, ostensibly a two-level system. In the embodiments disclosed herein, the two-level system can be coupled to a resonator for purpose of reading its state. If the artificial atom is in an excited state the output will be one frequency, while if the atom is in a ground state the output will be at a different frequency. Transduction at the quantum threshold is necessary to serve as a quantum equivalent to a modem. Transduction will serve as an aspect of a distributed quantum network based on superconducting QPUs, so that information can be distributed to other devices.

Thus, in certain embodiments, superconducting radiofrequency (SRF) cavities can be used in concert with bi-directional quantum transduction technology disclosed herein. High quality factor (Q) hybrid bulk microwave resonators are used to up/down-convert the information to/from the optical regime. The coupling between high-Q SRF cavities with nonlinear electro-optic resonators and modulators can support powerful quantum networks.

Hybrid quantum systems for quantum transduction can include superconducting bulk niobium (Nb) resonators coupled to non-centrosymmetric crystals. The latter are used to create interactions between microwave and optical fields using photonic RF three-wave-mixing processes. The same crystals can also be used as electro-optic modulators. An electric field applied on the material modulates the refractive index and the incident optical field linearly with the RF voltage (x²-chi square), known as the Pockels effect. A 3D hybrid system for quantum transduction can comprise the integration of bulk Nb SRF cavities with optical resonators made of Lithium Niobate (LN: LiNbO₃), which is an exemplary electro-optic material, with a large electro-optic coefficient (r₃₃=31 pm/V at 9 GHz) and low optical loss. Aluminum Nitride (AlN) is also a non-centrosymmetric material, with a lower piezoelectric efficiency. Bulk electro-optic modulators can achieve a high optical quality factor in the range of Qₒₚₜ˜ 10⁶-10⁸.

These crystals provide low noise and high flexibility in mechanical designs to mitigate piezoelectric coupling with the microwave fields. Dielectric losses are well mitigated in large RF volumes, as demonstrated in Quantum Information Science (QIS) applications.

The cavity electro-optic interaction can be described with a triple-resonance scheme, in which the pump optical mode (p) is driven to coherently couple the optical signal mode (a) with the microwave mode (b), with the electrooptic (EO) coupling strength geo. The Hamiltonian to model this system can be reduced to equation (1) as follows:

$$\hat{H} = {ℏg}_{eo} ( {pa}^{†} + {p}^{†} a ) ( b + {b}^{†} ) \qquad ( 1 )$$

The bidirectional conversion efficiency (n-eta) depends on both the conversion and the coupling losses as given by equation (2):

$$η = \frac{{κ}_{a , ex}}{{κ}_{a}} \frac{{κ}_{b , ex}}{{κ}_{b}} \times \frac{4 C}{{( 1 + C )}^{2}} , C = \frac{4 {n}_{p} {g}_{eo}^{2}}{{κ}_{a} {κ}_{b}} \qquad ( 2 )$$

where, for a generic m mode (m=a,b), kₘ is the total loss rate, considering both the intrinsic and external losses: kₘ=k_{m,ex}+k_{m,i}. C is the cooperativity between the optical and the microwave modes, which depends on the photon number in the pump mode (np).

The second term of Equation (2) is the internal efficiency given by equation 3:

$${η}_{i} = \frac{4 C}{{( 1 + C )}^{2}} \qquad ( 3 )$$

Transduction approaches require the presence of a strong laser field that is used to bridge the energy gap between optical and microwave excitations. In a three-wave mixing scheme, the operation mode is defined by the laser pump detuning.

In a Red-detuned scheme, the laser can be tuned below the optical resonant frequency. This is an exemplary operation mode for quantum transducers to achieve high conversion efficiency with low noise. Maximum (unitary) conversion efficiency (C=1) is achieved at the critical coupling given in equation (4) in the ideal case of zero parasitic losses:

$$4 {n}_{p} {g}_{eo}^{2} = {κ}_{a} {κ}_{b} \qquad ( 4 )$$

When Blue-detuned, the laser is tuned above the optical resonant frequency. A pair of microwave and optical photons are created with non-classical correlation between them. This two-mode squeezing process can be used to create entanglement between remote quantum systems. Low losses in long coherence quantum memories can be leveraged to enhance the transduction efficiency while keeping the entanglement fidelity in quantum networks high.

It should be appreciated that bulk Nb SRF cavities are attractive for quantum applications because of the high density of the electromagnetic fields in large microwave volumes. Tesla-shape cavities developed for particles accelerators have demonstrated E_{MAX}˜ 10 MV/m, with Q>10¹⁰. In transduction, the localization of the electromagnetic fields within the cavity enhances light-matter interactions and thus the electro-optic effect for the systems and methods disclosed herein. The resonators can be optimized to operate in particle accelerators, therefore sophisticated hybridization techniques can be implemented to realize quantum applications with these devices, acting both on geometries and coupling to achieve optimal performances.

In the design of superconducting radio frequency (SRF) cavities, the G factor, given by equation (5), describes the relationship between the cavity design and the surface resistance Rs. This parameter considers the imperfections of the cavities and the resistive losses that impact on the quality factor, as in equation (6). U is the energy stored in the cavity and Pₗₒₛₛ is the power dissipated by the cavity walls.

$$G = \frac{{ω}_{0} {μ}_{0} {\int }_{V} {\vert H \vert}^{2} dv}{{\int }_{S} {\vert H \vert}^{2} ds} \qquad ( 5 )$$

$$Q = \frac{{ω}_{0} U}{{P}_{loss}} \qquad ( 6 )$$

The conversion efficiency, as in equation (2), defines the quality of the transduction process. Several parameters can have an impact on the conversion efficiency. Systems and methods disclosed herein include the design process to find an optimal agreement between coupling and quality factor to achieve maximum transduction efficiency.

In quantum transduction and in a three-wave-mixing scheme, the single photon coupling is directly proportional to the maximum electric field (E_{MAX}), and inversely proportional to the stored energy in the cavity.

If the electro-optic crystal is used as a modulator, it can be modelled as a capacitor (C). In certain embodiments varying geometries can be used to confine the electromagnetic modes across the capacitance given by equation (7) as:

$$V = \frac{ℸ \overline{{ℏ !}_{b}}}{2 C} \qquad ( 7 )$$

The disclosed embodiments can exhibit both high conversion efficiency and coupling, with an optimal overlap between microwave and optical fields. The following parameters have a direct impact on both efficiency and coupling:
The maximum electric field (E_{MAX}) on the electro-optic crystal;
The stored energy in the microwave cavity has a direct impact on the Q, which indicates energy loss relative to the amount of energy stored, see equation (6);
The filling factor is also a measure of the losses induced by the crystal in the hybridized cavity; and
The pump power typically ranges from fractions to a few mW. If the pump power is too high, the noise in the system will also increase.

The design geometry for a hybrid system can be optimized through microwave and multiphysics simulations. Different embodiments can be used for this purpose, each of them can be coupled with bulk non-centrosymmetric crystals acting as whispery gallery mode (WGM) resonators, as well as modulators. Most schemes allow coupling with superconducting qubits.

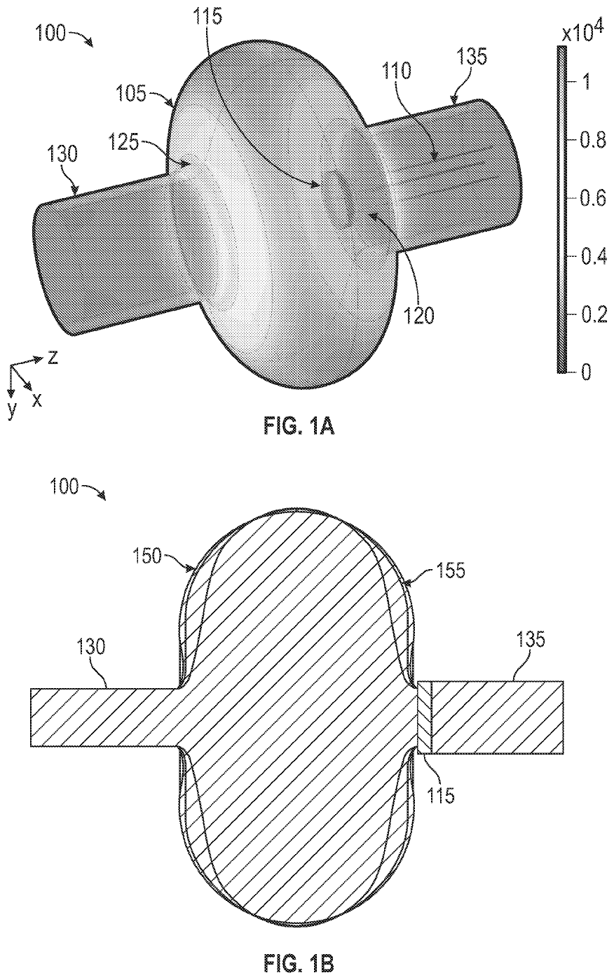

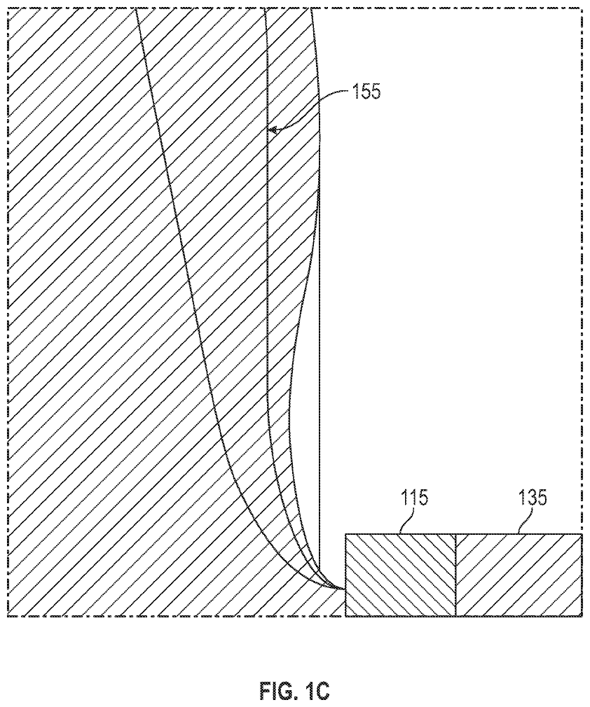

FIG. 1A illustrates an exemplary system 100, comprising a 9 GHz single cell cavity 105 configured to include an electro-optic crystal 115, which can comprise an LiNbO₃ cylinder, and three rods 110. The rods 110 can comprise sapphire rods 110. The LiNbO₃ cylinder 110 can be configured at or near the opening 120 of the cavity 105. It should be understood that the illustrated cavity 105 is exemplary and in other embodiments, other cavities can be used, including custom designed cavities. FIG. 1A further illustrates surface electric fields 125 associated with the cavity 105.

FIG. 1B illustrates additional aspects of the system 100 with a TESLA shaped cavity. Specifically beam pipe 130 of the cavity 105 can have a smaller diameter than beam pipe 135 where the electro-optic crystal 115 is located. The relative sizes of the beam pipe 130 and beam pipe 135 will depend on the specific application, but in certain embodiments, if beam pipe 130 is 4 mm, beam pipe 135 can be 5 mm. the wider beam pipe 135 is configured to house the electro-optic crystal 115 and rods 110.

FIG. 1C show exemplary cavity geometries 150, including cavity hybridization and the fundamental electrical field lines 155 across a bulk crystal cylinder 115 which, in certain embodiments, can comprise mm-sized disk. The microwave modes of the SRF cavity couple along the z-cut of the crystal or whispery gallery mode resonators. This hybrid cavity exhibits low filling factor and higher quality factor, but low coupling.

Reentrant and quarter-wave (λ/4) resonators can be employed in the context of QIS, for quantum memory and material characterizations, due to the simple design and integration. Using accurate designs, it is possible to precisely predict the modes and the coupling to qubits of nonlinear materials.

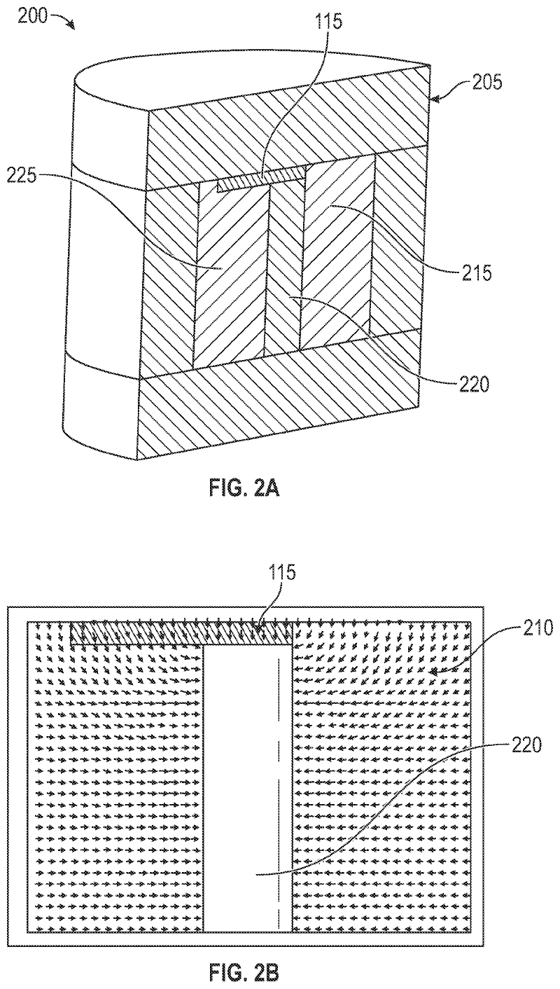

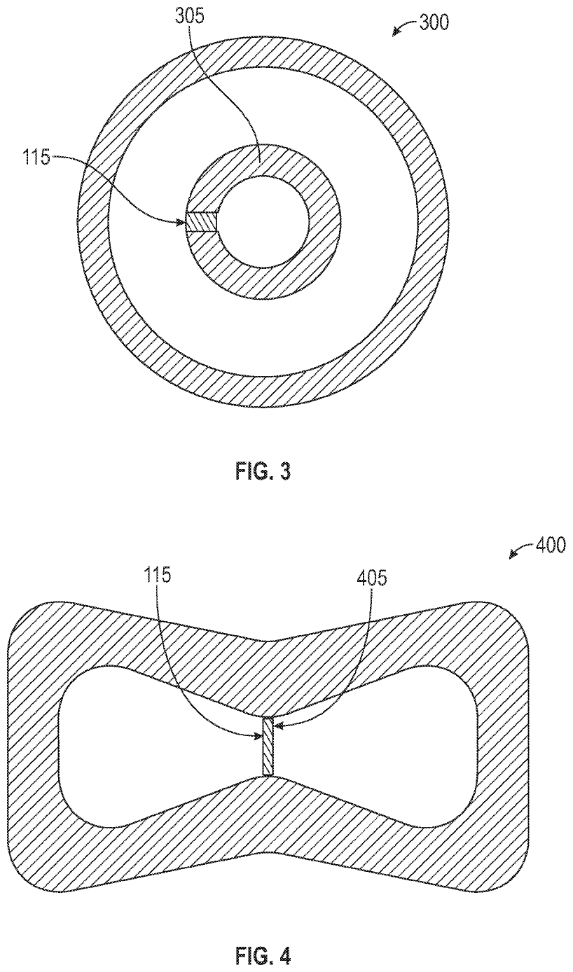

FIG. 2A and FIG. 2B illustrates exemplary cavity geometry 205 and electric field lines 210 across a nonlinear material 215 for a microwave cavity 200 with an electro-optic crystal 115 embedded therein, in accordance with the disclosed embodiments. The cavity 205 can be metal and can be superconducting or normal conducting. The crystal disc 115 is illustrated offset on metal stub 220 in vacuum 225, used to hold the crystal and tune the microwave frequency. The operation of the microwave cavity 200 can be both in whispering gallery mode and as an electro-optic modulator.

FIG. 2B illustrates detail of the electro-optic crystal 115 with the microwave field excited. The electric field components 210 are parallel to the principal axis of the electro-optic crystal. The electric field 210 is illustrated in the vacuum volume. Note, the intensity of the electric field 210 is lower than in the crystal 115.

Other cavities' structures can also be used according to design parameters. Such structures can include, but are not limited to, a whispering gallery mode (WGM) optical resonator enclosed in a 3D superconducting pillbox cavity. FIG. 3 illustrates a cross-sectional view of a split-ring cavity 300 with an electro-optic crystal 115 placed in an inner metal fitting 305. Field lines 310 are further illustrated. The split-ring cavity 300 can comprise a resonant coaxial cavity coupled to an electro-optic crystal 115.

FIG. 4 illustrates another exemplary cross-sectional view of a cavity 400 comprising a bow-tie cavity 400 coupled to an electro-optic cavity. In certain embodiments, the mm-sized electro-optic crystal disk 115 can be placed in between the metal walls 405 of the cavity 400.

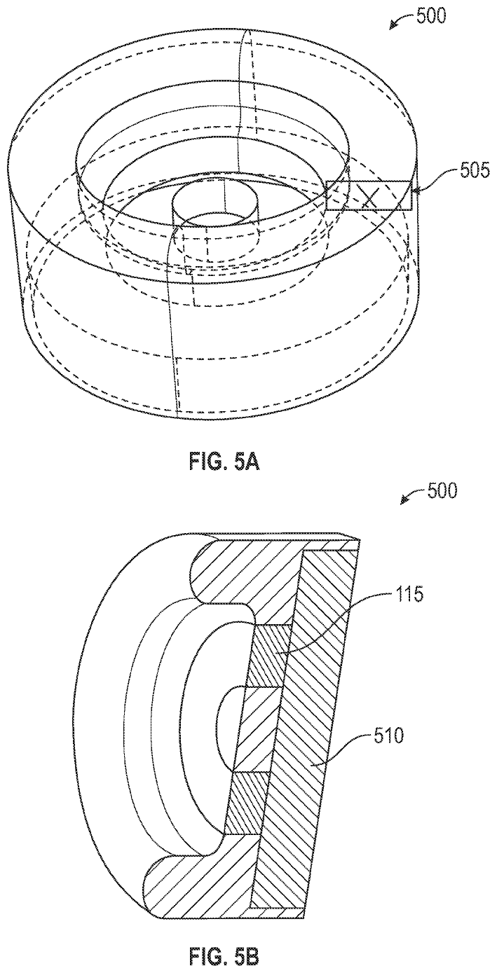

FIG. 5A illustrates aspects of a 9 GHz dipole mode cavity 500, in accordance with the disclosed embodiments. In this embodiment, the cavity 500 comprises a resonant cavity with an electro-optic crystal 115 embedded and coupled to a superconducting qubit. The dipole microwave mode is used in three-wave mixing schemes for momentum conservation. This embodiment can be adapted to couple with a superconducting qubit 505.

FIG. 5B illustrates a cross-sectional view of the cavity 500 comprising a resonant cavity with an electro-optic crystal 115 embedded therein. In this view a metal stub 510 is illustrated. The metal stub 510 is configured to hold the crystal 115 and tune the microwave frequency of the cavity 500.

In other embodiments, multi-resonators can also be used, in which high-Q resonators hybridized with electro-optics materials will be strongly coupled to a central resonator. Multi-atomic ensembles can be selected to increase the efficiency and the coupling strength as elements of the disclosed embodiments.

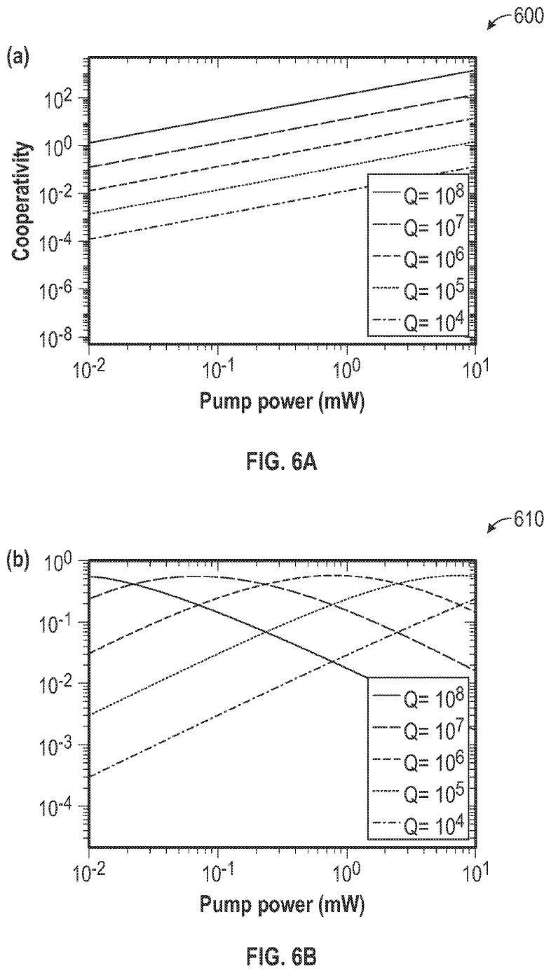

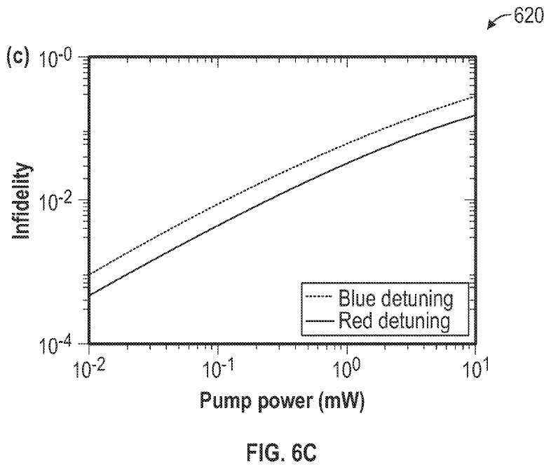

Following the described process, the efficiency, cooperativity, and infidelity of quantum transduction can be compared against the laser pump power and the RF quality factor (Q). FIG. 6A provides chart 600 illustrating that hybrid devices with higher Q achieve maximum conversion efficiency at lower pump powers. In addition, the cooperativity, illustrated by chart 610 in FIG. 6B, scales linearly with respect to the quality factor and the pump power.

The infidelity of generating entangled states in two remote quantum devices in the blue- and red-detuned regimes is shown in chart 620 of FIG. 6C. A larger pump power increases the probability of generating more microwave photons in the resonators, reducing therefore the fidelity of entanglement between two remote quantum devices.

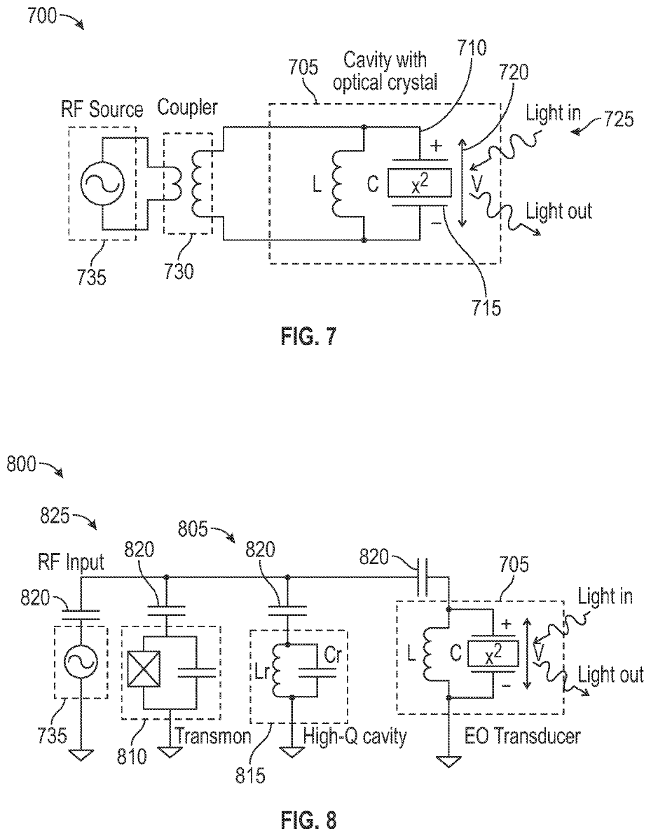

FIG. 7 illustrates an exemplary system 700 illustrating the principal of quantum transduction. As illustrated, an RF resonator is coupled to a nonlinear optical crystal 705. In certain embodiments the RF resonator can comprise any of those illustrated herein, or other such RF resonator, and the nonlinear optical crystal can comprise a crystal such as electro-optic crystal disc 115.

The electro-optic modulator 710 is modelled as a capacitor 715 for purposes of illustration, in which the applied voltage 720 changes the refractive index and therefore modulates the incident optical field 725. The optical fields can also modulate the microwave field to reverse the coefficient effect and down-convert the optical signal (optical-to-microwave conversion). A coupler 730 can be used to connect the cavity with the optical crystal 705 to an RF source 735.

FIG. 8 illustrates a system 800 for interconnected quantum devices in a quantum node 805, in accordance with the disclosed embodiments. In the system 800, the EO Transducer comprising the SRF cavity 705 and LiNbO₃ (or AlN) crystal 115 is coupled to both a transmon qubit 810 and an electro-optical modulator cavity 815 with a series of capacitors 820. The RF input 825 is provided by the RF source 735. In the system 800 the quantum memory can distinguish the entangled heralded photons detected by the electro-optic transducer.

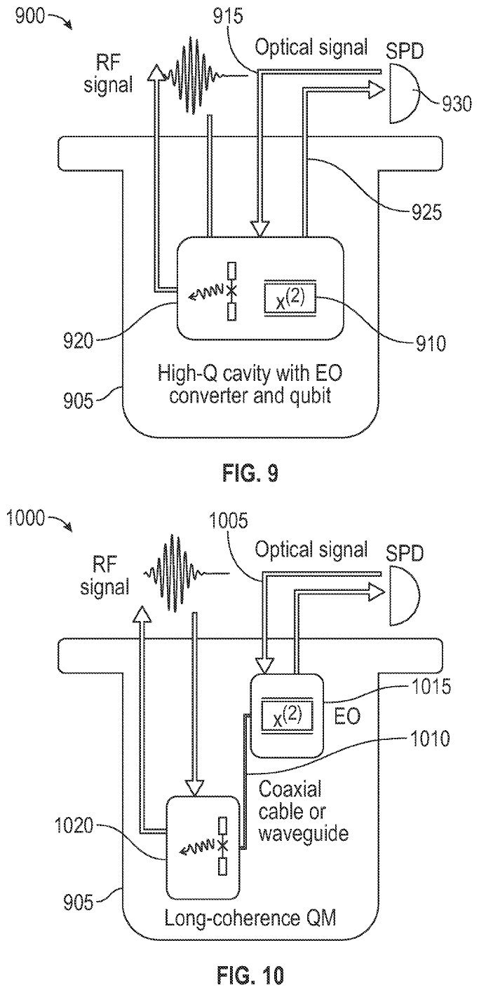

FIG. 9 shows a block diagram 900 of a measurement and characterization network in a dilution refrigerator 905 of an SRF cavity hybridized with a nonlinear crystal 910 and RF cavity 920, and eventually a transmon qubit in accordance with the disclosed embodiments. The laser input 915 excites the nonlinear crystal 910 through optical fibers, and the modulated and reflected signal 925 is monitored by single photon detectors (SPD) 930. The SRF cavity can be excited via cryogenic RF cables.

FIG. 10 depicts an interconnected quantum network 1000 in accordance with the disclosed embodiments. The quantum network 1000 can transduce quantum optical signals 1005 from the microwave regime to the optical regime and vice-versa. The embodiment includes a dilution refrigerator 905 housing a wave guide (or coaxial cable) 1010 connecting the EO 1015 (e.g., crystal 115) to the RF cavity 1020. Different protocols can be considered for quantum communications, including but not limited to a variable coupler to synchronize the catch and release operations. A twin system can be placed in a different location to create a two-node quantum network connected by electro-optic transducers.

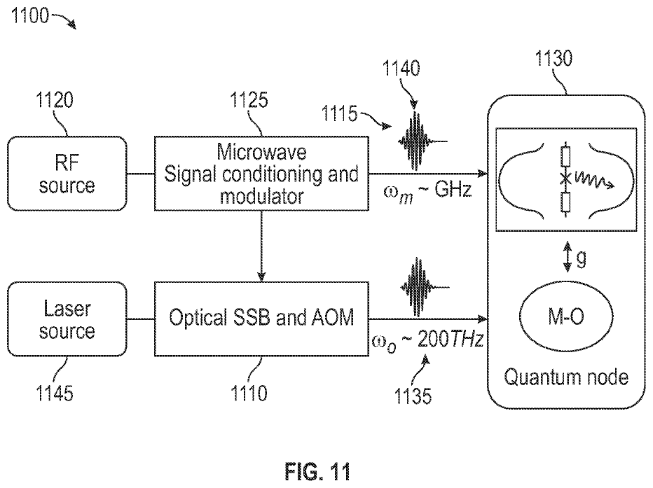

FIG. 11 illustrates an exemplary schematic of microwave-to-optical transduction system 1100 integrated in an HQS and the related measurement and control network, in accordance with the disclosed embodiments. The system includes an RF source 1120 providing a signal to a microwave and signal conditioning modulator 1125. In this picture a single-sideband (SSB) technique is used to generate the optical input at telecom wavelength 1140. The signal to the quantum node 1115 can be in the GHz range. The Optical SSB 1110 can receive a signal from a laser source 1145 and can likewise provide a signal 1135 to the quantum node 1130 with a frequency on the order of ˜ 200 THz.

The transduction systems and methods disclosed herein require the presence of a strong laser field to bridge the energy gap between the optical and microwave excitation states, that can be multiple orders of magnitude apart. The slower thermal transient in the 3D resonators allows an increase in pump power and allows operations at the quantum limit, also in presence of relative high pump power ˜mW.

As detailed herein, the embodiments are directed to a quantum transduction hybrid system based on the coupling of long-coherence superconducting cavities with electro-optic crystals to achieve high-efficiency and high-fidelity in quantum communication protocols and quantum sensing. The embodiments exploit hybrid coherent resonance systems and a bi-directional quantum transduction technology based on high-quality factor (Q) microwave cavities to up/down-convert the information to/from the optical regime. The coupling between high-Q superconducting radiofrequency (SRF) cavities with nonlinear electro-optic resonators can support a powerful quantum network. Moreover, such quantum systems with very low parasitic maximize conversion efficiency at milli-Kelvin temperatures as well as high fidelity in quantum states transportation.

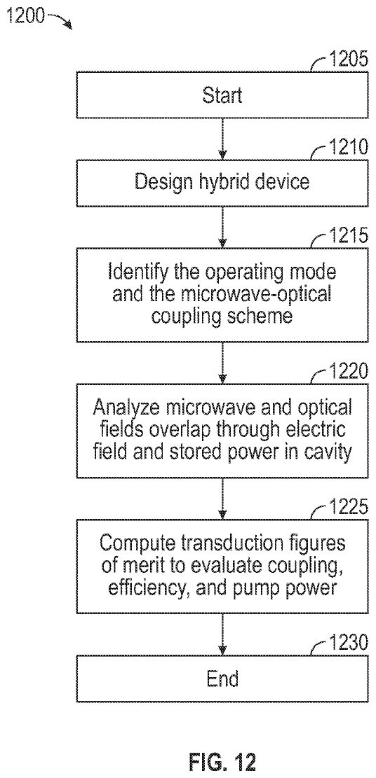

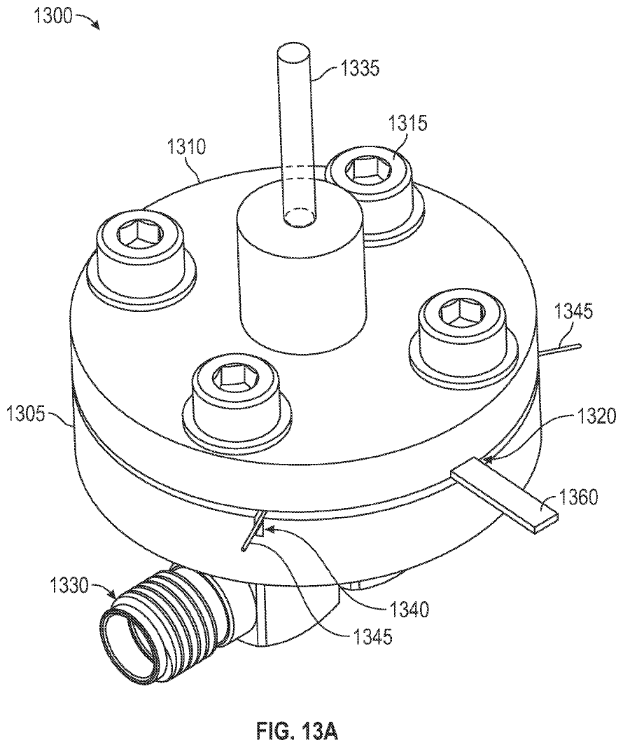

FIG. 12 illustrates a method 1200 for selecting the location and optimal cavity shape in accordance with the disclosed embodiments. The method begins at 1205.

At step 1210, the method involves first designing a hybrid device (e.g., an Electro-optical modulator or resonator+SRF cavity). Next, the operating mode and the related microwave-optical coupling scheme and be identified at 1215. It is then necessary to analyze microwave and optical fields overlap through electric field and stored power in cavity, as illustrated at step 1220. Once these parameters are identified, the transduction figures of merit can be determined to evaluate coupling, efficiency, and pump power at step 1225. The method ends at 1230. The method 1200 is of particular value for use with a non-linear crystal both as a whispery gallery resonator and electro-optic modulators. Most cavity shapes can work in both cases.

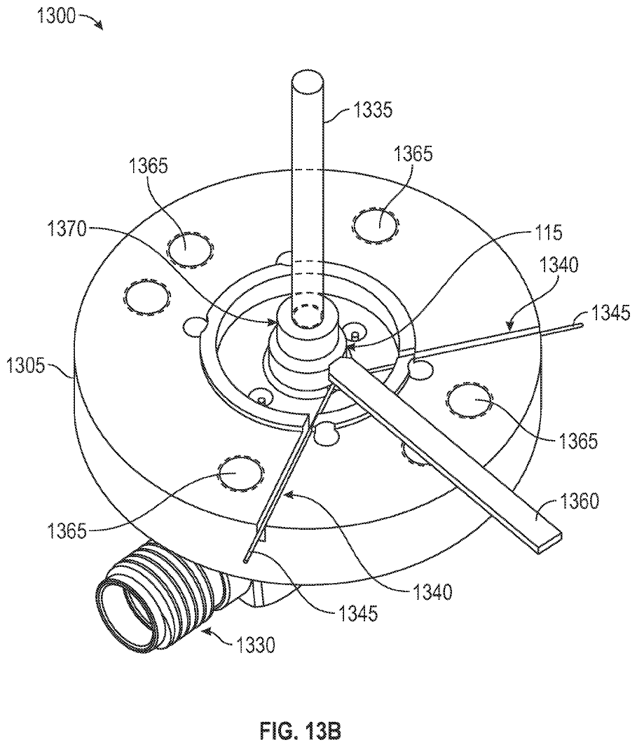

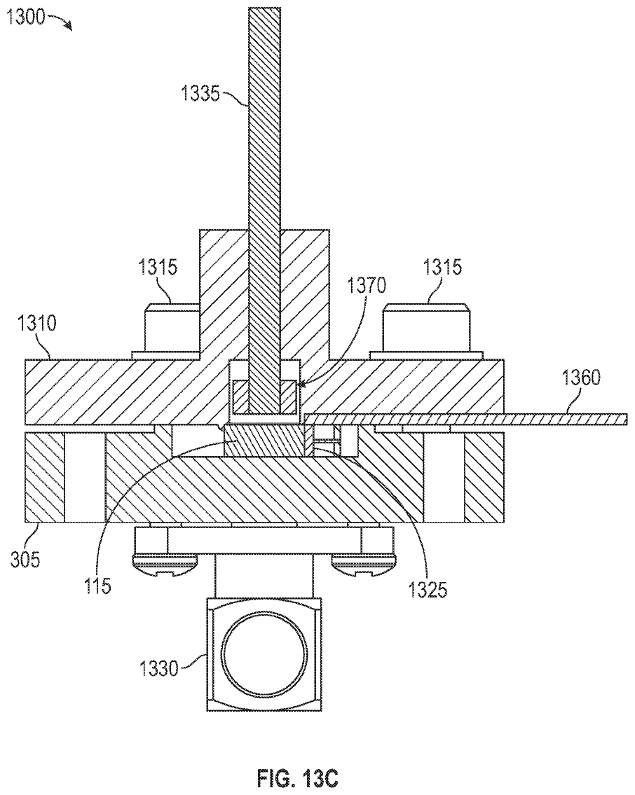

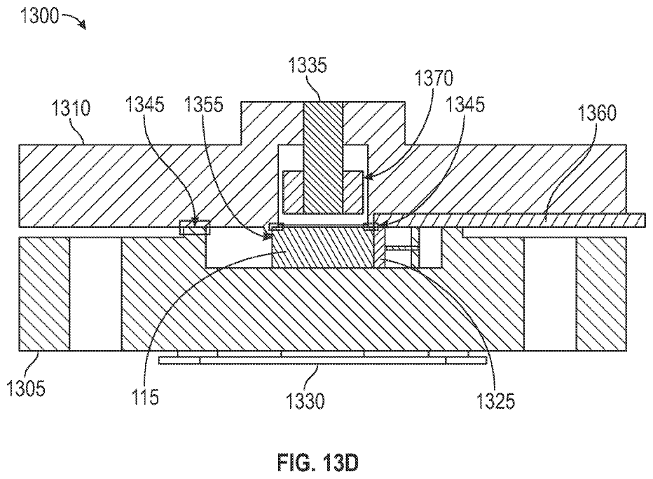

FIG. 13A, illustrates aspects of a system 1300 for transduction using resonant cavities and electro-optical crystals in accordance with the disclosed embodiments. The system 1300 includes a cavity 1305, which can comprise a resonant cavity such as an RF resonant cavity, a superconducting bulk cavity, or other such cavity as detailed herein. The cavity 1305 can be covered by a cover 1310. The cavity cover 1310 can comprise an oxygen free copper or regular copper in the case of a room temperature cavity 1305. The material of the cover 1310 may be different for a superconducting cavity. Turner rods 1315 can be configured in the cover 1305.

The cover 1310 can include a holder slot 1320 allowing a prism holder 1360 to extend into the assembly to hold a prism 1325 as further detailed herein. A coaxial jack 1330 can be operably coupled to the cavity 1305.

FIG. 13B illustrates the system 1300 with the cover 1310 removed. As illustrated, the cavity 1305 can include mounting channels 1365 for turner rods 1315. The electro optical crystal 115 is mounted to the cavity 1305 using a plunger 1370, which can comprise a metal disc, connected to a sapphire holder rod 1335. The sapphire holder rod 1335 and plunger 1370 are used to hold the electro-optical crystal 115. The cavity 1305 includes channels 1340 configured to allow light 1345 (e.g., laser light) to reach the prism 1325.

FIG. 13C provides an elevation view of the system 1300, in accordance with the disclosed embodiments. The prism 1325 is adjacent to the electro-optical crystal 115 so that the laser light 1345 can enter and exit through the prism 1325 and channels 1340. In certain embodiments, the prism 1325 is glued to the metal prism holder 1360, which is connected to a translation stage to vary the optical coupling.

FIG. 13D illustrates contact surfaces 1345 between the cover 1310, cavity 1305, and electro-optical crystal 115. The cover 1310 can include a lip 1355 configured to fit around the electro-optical crystal 115.

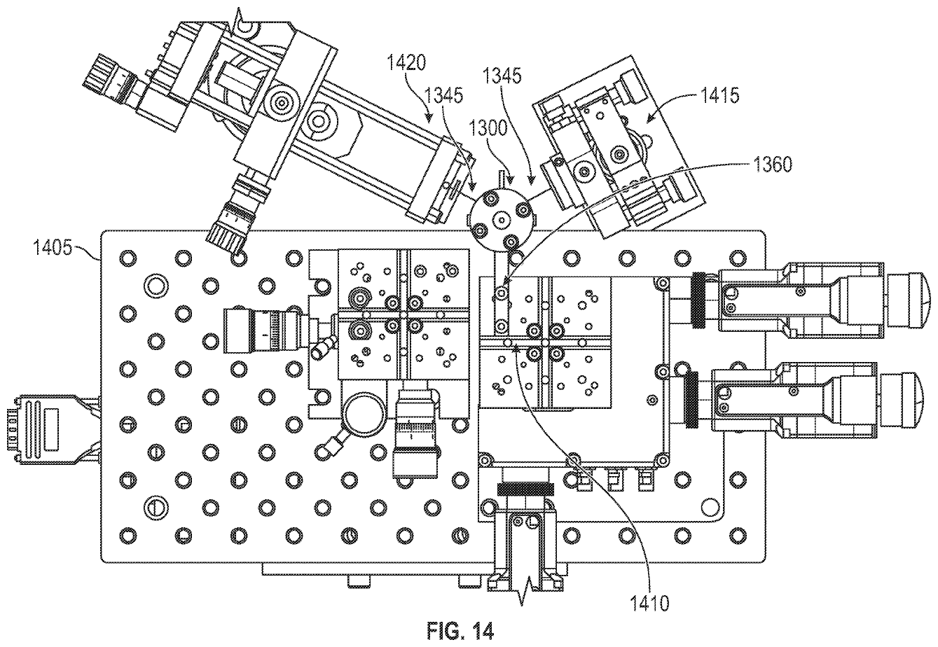

FIG. 14 illustrates another embodiment of the system 1300, in accordance with the disclosed embodiments. In certain embodiments, the system 1300 can be mounted to a platform 1405, such as an optical table. The prism holder 1360 can be mounted to the platform 1405 forming a translation stage 1410 to modify the relative position between the electro-optic optical cavity 1305 and the prism 1325. Likewise, a first laser translation stage 1415 and a second laser translation stage 1420 are provided to modify the orientation of the laser light 1345.

With the disclosed system 1300 the dipole mode is excited. The field is concentrated by the edge of the crystal 115. The prism can be used for the optical coupling and can be placed in an area in which the electric field is close to zero to minimize the electromagnetic perturbation in the cavity.

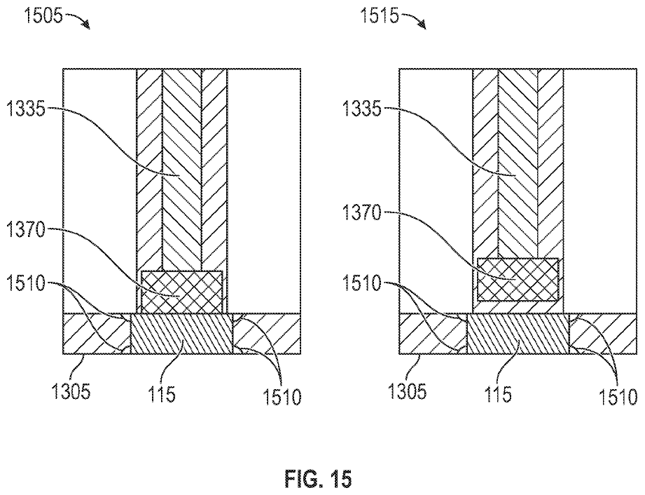

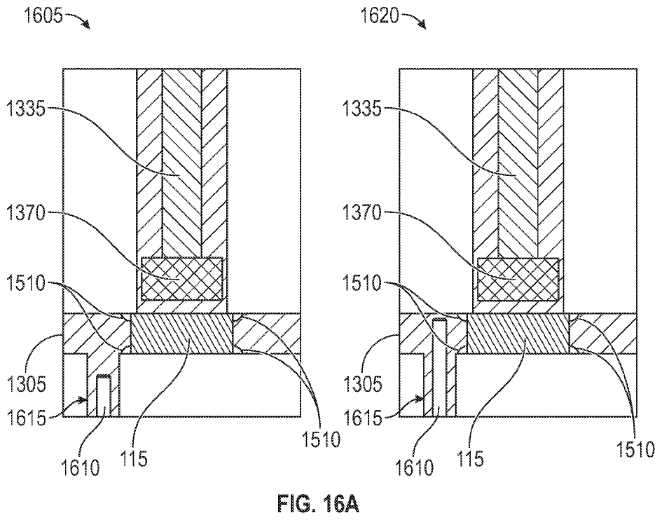

FIG. 15 illustrates an exemplary mechanism to change the microwave volume and tune the resonant frequency of the cavity 1305. As illustrated in first position 1505, the sapphire holder 1335 and plunger 1370 are connected to the crystal 115. Lip locks 1510 can be used to hold the crystal in place in the cavity 1305. In second position 1515, the sapphire rod 1335 and plunger 1370 are lifted above the crystal 115. In this way the microwave volume can be changed to tune the resonant frequency.

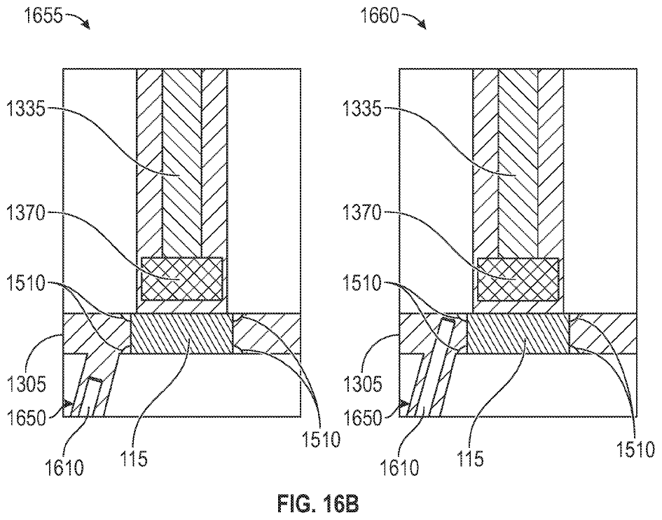

In certain embodiments an antenna can be used to modify the external microwave coupling. FIG. 16A illustrates an exemplary antenna, which can be used to tune the microwave coupling, in accordance with the disclosed embodiments. In the first antenna position 1605 the antenna 1610 can be provided in an antenna slot 1615 at a lower position. At second antenna position 1620, the antenna tip is adjusted toward the crystal 115. By adjusting the relative location of the antenna 1610, the microwave coupling can be tuned.

FIG. 16B illustrates an exemplary angled antenna configuration, which can be used to tune the microwave coupling, in accordance with the disclosed embodiments. In the first antenna position 1655 the antenna 1610 can be provided in an angled antenna slot 1650 at a lower position. At second antenna position 1660 the antenna 1610 tip is adjusted toward the crystal 115. By adjusting the relative location of the antenna 1610, the microwave coupling can be tuned.

Based on the foregoing, it can be appreciated that a number of embodiments are disclosed herein. For example, in an embodiment a system comprises a resonant bulk cavity and at least one electro-optic crystal configured in the resonant bulk cavity.

In an embodiment, the resonant bulk cavity comprises an RF resonating cavity.

In an embodiment, the system comprises at least one rod extending from the electro-optic crystal. In an embodiment, the at least one rod comprises three rods. In an embodiment, the at least one rod further comprises at least one sapphire rod.

In an embodiment the system further comprises a beam pipe associated with the resonant bulk cavity wherein the at least one electro-optic crystal is configured proximate to the beam pipe.

In an embodiment, the electro-optic crystal comprises one of Lithium Niobate (LiNbO₃) and Aluminum Nitride (AlN).

In an embodiment, the resonant bulk cavity comprises a TESLA shaped cavity. In an embodiment, the resonant bulk cavity comprises one of a superconducting cavity and a microwave cavity. In an embodiment, the resonant bulk cavity comprises a split ring cavity. In an embodiment, the resonant bulk cavity comprises a bow-tie cavity.

In another embodiment, a transduction system comprises a resonant RF cavity, at least one electro-optic crystal configured in the resonant RF cavity proximate to a beam pipe associated with the resonant RF cavity, and at least one rod extending from the electro-optic crystal into the beam pipe.

In an embodiment, the resonant RF cavity comprises one of a superconducting cavity and an RF resonating cavity. In an embodiment, resonant RF cavity comprises one of: a TESLA shaped cavity, a reentrant cavity, a split ring cavity, a bow-tie cavity, and a custom designed RF cavity.

In an embodiment, the electro-optic crystal comprises one of Lithium Niobate (LiNbO₃) and Aluminum Nitride (AlN). In an embodiment, the at least one rod further comprises at least one sapphire rod.

In another embodiment a system comprises an EO transducer, a resonant cavity coupled to the EO transducer, a transmon qubit coupled to the EO transducer, and an RF source configured to provide a signal to the EO transducer. In an embodiment, the EO transducer comprises an RF resonating cavity and electro-optic crystal configured in the RF resonating cavity. In an embodiment, the RF resonating cavity comprises one of: a TESLA shaped cavity, a reentrant cavity, a split ring cavity, a bow-tie cavity, and a custom designed RF cavity. In an embodiment, the electro-optic crystal comprises Lithium Niobate (LiNbO₃) and Aluminum Nitride (AlN).

It will be appreciated that variations of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A system comprising:
a resonant bulk cavity; and
at least one electro-optic crystal configured in the resonant bulk cavity.

2. The system of claim 1 wherein the resonant bulk cavity comprises:
an RF resonating cavity.

3. The system of claim 1 further comprising:
at least one rod extending from the electro-optic crystal.

4. The system of claim 3 wherein the at least one rod comprises three rods.

5. The system of claim 3 wherein the at least one rod further comprises at least one sapphire rod.

6. The system of claim 1 further comprising:
a beam pipe associated with the resonant bulk cavity wherein the at least one electro-optic crystal is configured proximate to the beam pipe.

7. The system of claim 1 wherein the electro-optic crystal comprises one of:
Lithium Niobate (LiNbO₃); and
Aluminum Nitride (AlN).

8. The system of claim 1 wherein the resonant bulk cavity comprises:
a TESLA shaped cavity.

9. The system of claim 1 wherein the resonant bulk cavity comprises one of:
a superconducting cavity; and
a microwave cavity

10. The system of claim 1 wherein the resonant bulk cavity comprises:
a split ring cavity.

11. The system of claim 1 wherein the resonant bulk cavity comprises:
a bow-tie cavity.

12. A transduction system comprising:
a resonant RF cavity;
at least one electro-optic crystal configured in the resonant RF cavity proximate to a beam pipe associated with the resonant RF cavity; and
at least one rod extending from the electro-optic crystal into the beam pipe.

13. The transduction system of claim 12 wherein the resonant RF cavity comprises one of:
a superconducting cavity; and
an RF resonating cavity.

14. The transduction system of claim 12 wherein the resonant RF cavity comprises one of:
a TESLA shaped cavity;
a reentrant cavity;
a split ring cavity;
a bow-tie cavity; and
a custom designed RF cavity.

15. The system of claim 12 wherein the electro-optic crystal comprises one of:
Lithium Niobate (LiNbO₃); and
Aluminum Nitride (AlN).

16. The transduction system of claim 12 wherein the at least one rod further comprises at least one sapphire rod.

17. A system comprising:
an EO transducer;
a resonant cavity coupled to the EO transducer;
a transmon qubit coupled to the EO transducer; and
an RF source configured to provide a signal to the EO transducer.

18. The system of claim 17 wherein the EO transducer comprises:
an RF resonating cavity; and
electro-optic crystal configured in the RF resonating cavity.

19. The system of claim 18 wherein the RF resonating cavity comprises one of:
a TESLA shaped cavity;
a reentrant cavity;
a split ring cavity;
a bow-tie cavity; and
a custom designed RF cavity.

20. The system of claim 18 wherein the electro-optic crystal comprises:
Lithium Niobate (LiNbO₃); and
Aluminum Nitride (AlN).
